(19) United States
(12) Patent Application Publication
(10) Pub. No.: US 2025/0078860 A1
(43) Pub. Date: Mar. 6, 2025

(54) INFORMATION CREATION METHOD AND INFORMATION CREATION DEVICE

(71) Applicant: FUJIFILM Corporation, Tokyo (JP)

(72) Inventors: Toshiki KOBAYASHI, Saitama (JP); Yuya NISHIO, Saitama (JP); Masaru KOBAYASHI, Saitama (JP); Kei YAMAJI, Saitama (JP)

(73) Assignee: FUJIFILM Corporation, Tokyo (JP)

(21) Appl. No.: 18/951,813

(22) Filed: Nov. 19, 2024

Related U.S. Application Data
(63) Continuation of application No. PCT/JP2023/019903, filed on May 29, 2023.

(30) Foreign Application Priority Data
Jun. 8, 2022 (JP) 2022-092808

(51) Int. Cl. G10L 25/57

(52) U.S. Cl. CPC G10L 25/57

(57) ABSTRACT

Provided are an information creation method and an information creation device for efficiently creating accessory information on characteristics of each of a plurality of sounds included in sound data.

An information creation method according to one embodiment of the present invention includes a first acquisition step of acquiring sound data including a plurality of sounds emitted from a plurality of sound sources, a setting step of setting accuracy for the sound source or the sound, and a creation step of creating information on characteristics of the sound as accessory information on video data corresponding to the sound data, based on the accuracy.

### CROSS-REFERENCE TO RELATED APPLICATIONS

This application is a Continuation of PCT International Application No. PCT/JP2023/019903 filed on May 29, 2023, which claims priority under 35 U.S.C. § 119 (a) to Japanese Patent Application No. 2022-092808 filed on Jun. 8, 2022. The above applications are hereby expressly incorporated by reference, in their entirety, into the present application.

### BACKGROUND OF THE INVENTION

### 1. Field of the Invention

One embodiment of the present invention relates to an information creation method and an information creation device.

### 2. Description of the Related Art

In a case in which a video file including sound data including sound emitted from a sound source and video data corresponding to the sound data is created, information on characteristics of the sound may be created as accessory information on the video data. Examples of the characteristics of the sound include physical characteristics such as a volume, an amplitude, and a frequency, a type of the sound source, and a determination result based on the sound (see, for example, WO2011/145249A).

### SUMMARY OF THE INVENTION

The sounds (non-verbal sounds such as environmental sounds) recorded as the sound data are diverse, and it is not necessary to create the accessory information uniformly according to a unified standard for all types of sounds. In view of this point, there is a demand for efficiently creating the accessory information on the characteristics of the sound for each of the plurality of sounds included in the sound data.

An object of the present invention is to provide an information creation method and an information creation device for efficiently creating accessory information on characteristics of each of a plurality of sounds included in sound data.

In order to achieve the above-described object, an aspect of the present invention relates to an information creation method comprising: a first acquisition step of acquiring sound data including a plurality of sounds emitted from a plurality of sound sources; a setting step of setting accuracy for the sound source or the sound; and a creation step of creating information on characteristics of the sound as accessory information on video data corresponding to the sound data, based on the accuracy.

In the setting step, an importance level may be set for the sound or the sound source, and the accuracy is set according to the importance level.

The sound may be a non-verbal sound.

The information creation method according to the aspect of the present invention may further comprise a second acquisition step of acquiring video data including a plurality of image frames. In the setting step, the accuracy for the sound source may be set according to whether or not the sound source is present within an angle of view of a corresponding image frame among the plurality of image frames.

The information creation method according to the aspect of the present invention may further comprise a determination step of determining whether or not the sound satisfies a predetermined criterion in a case in which the sound source is not present within an angle of view of a corresponding image frame. In the setting step, the accuracy for the sound may be set to be higher in a case in which the sound satisfies the predetermined criterion than in a case in which the sound does not satisfy the predetermined criterion.

The information creation method according to the aspect of the present invention may further comprise a change step of, in a case in which the sound satisfies the predetermined criterion, changing an orientation of an imaging lens of an imaging apparatus such that the imaging lens approaches a direction of the sound source or reducing zoom magnification of the imaging apparatus such that the sound source is included in the angle of view of the image frame.

In the setting step, the accuracy for the sound source may be set based on a result of image recognition on the sound source in a corresponding image frame or apparatus information associated with the image frame for an imaging apparatus that captures the image frame.

In the setting step, the accuracy for the sound source may be set based on the apparatus information. In this case, the apparatus information may be information on a focal position of the imaging apparatus in the image frame or a gaze position of a user of the imaging apparatus in the image frame.

In the creation step, information on whether or not the sound source is present within an angle of view of a corresponding image frame may be created as the accessory information.

The information creation method according to the aspect of the present invention may further comprise an inspection step of inspecting whether or not the sound satisfies an inspection criterion in a case in which the accuracy according to the importance level satisfies a predetermined condition. In this case, in the creation step, information on an inspection result obtained in the inspection step may be created as the accessory information.

In the creation step, reliability information on reliability of the inspection result may be further created as the accessory information.

In the creation step, importance level information on the importance level may be created as the accessory information.

In a case in which the accuracy according to the importance level satisfies a first condition, in the creation step, onomatopoeic word information in which the sound is converted into text as an onomatopoeia word may be created as the accessory information.

In a case in which the accuracy according to the importance level satisfies a second condition, in the creation step, mimetic word information in which a state of the sound source in a corresponding image frame is converted into text as a mimetic word may be further created as the accessory information.

Another aspect of the present invention relates to an information creation device comprising: a processor, in which the processor is configured to: acquire sound data including a plurality of sounds emitted from a plurality of sound sources; set accuracy for the sound source or the sound; and create information on characteristics of the sound as accessory information on video data corresponding to the sound data, based on the accuracy.

### BRIEF DESCRIPTION OF THE DRAWINGS

FIG. 1 is an explanatory diagram of a video file.

FIG. 2 is a diagram related to video data and sound data.

FIG. 3 is a diagram showing a configuration example of an information creation device according to one embodiment of the present invention.

FIG. 4 is a diagram showing an example of accessory information.

FIG. 5 is a diagram showing an example of a positional relationship between an angle of view and a sound source.

FIG. 6 is a diagram related to a procedure of specifying a position of the sound source.

FIG. 7 is a diagram related to another example of the procedure of specifying the position of the sound source.

FIG. 8 is a diagram showing various types of information included in accessory information on the sound.

FIG. 9A is a diagram related to a function of an information creation device according to a first embodiment of the present invention.

FIG. 9B is a diagram showing an example of an imaging apparatus and a pan-tilt head according to the first embodiment of the present invention.

FIG. 10 is an explanatory diagram of onomatopoeic word information.

FIG. 11 is an explanatory diagram of mimetic word information.

FIG. 12 is a diagram showing an information creation flow according to the first embodiment of the present invention.

FIG. 13 is a diagram showing an example of a specific scene in which a video file is created in the first embodiment.

FIG. 14 is a diagram showing a flow of a creation step.

FIG. 15 is a diagram showing an example of accessory information on the sound created in a case of FIG. 13.

FIG. 16 is a diagram related to a function of an information creation device according to a second embodiment of the present invention.

FIG. 17 is a diagram showing an information creation flow according to the second embodiment of the present invention.

FIG. 18 is a diagram showing an example of a specific scene in which a video file is created in the second embodiment.

FIG. 19 is a diagram showing an example of accessory information on the sound created in a case of FIG. 18.

### DESCRIPTION OF THE PREFERRED EMBODIMENTS

Specific embodiments of the present invention will be described. The following embodiments are merely examples for facilitating understanding of the present invention and do not limit the present invention. The present invention may be modified or improved from the following embodiments without departing from the gist of the present invention. Further, the present invention includes its equivalents.

In the present specification, the concept of “device/apparatus” includes a single device/apparatus that exerts a specific function and includes a combination of a plurality of devices/apparatuses that exist independently and that are distributed but operate together (cooperate) to perform a specific function.

In the present specification, the term “person” means a subject that performs a specific action, and the concept of the “person” includes an individual, a group such as family, a corporation such as a company, and an organization.

In the present specification, the term “artificial intelligence (AI)” is a technology that realizes an intelligent function such as inference, prediction, and determination by using hardware resources and software resources. It should be noted that an algorithm of the artificial intelligence is optional, and examples thereof include an expert system, a case-based reasoning (CBR), a Bayesian network, and an inclusion architecture.

### <<One Embodiment of Present Invention>>

One embodiment of the present invention relates to an information creation method and an information creation device that create accessory information on video data included in a video file based on sound data included in the video file. One embodiment of the present invention relates to the video file including the accessory information.

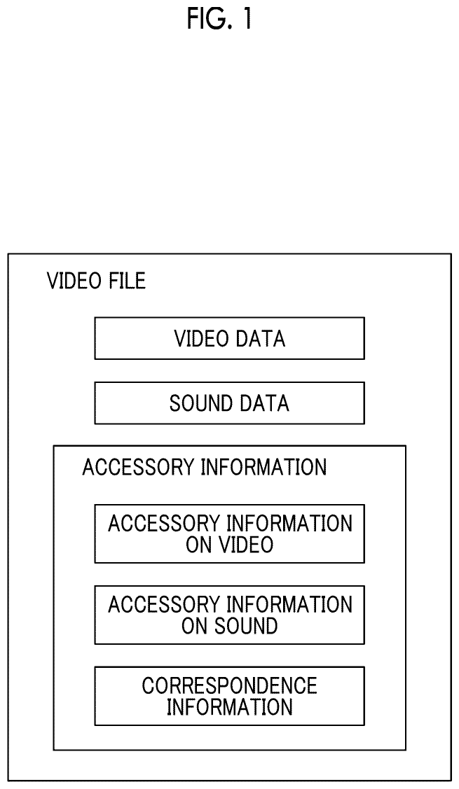

As shown in FIG. 1, the video file includes the video data, the sound data, and the accessory information. Examples of a file format of the video file include Moving Picture Experts Group (MPEG)-4, H.264, Motion JPEG (MJPEG), High Efficiency Image File Format (HEIF), Audio Video Interleave (AVI), QuickTime file format (MOV), Windows Media Video (WMV), and Flash Video (FLV).

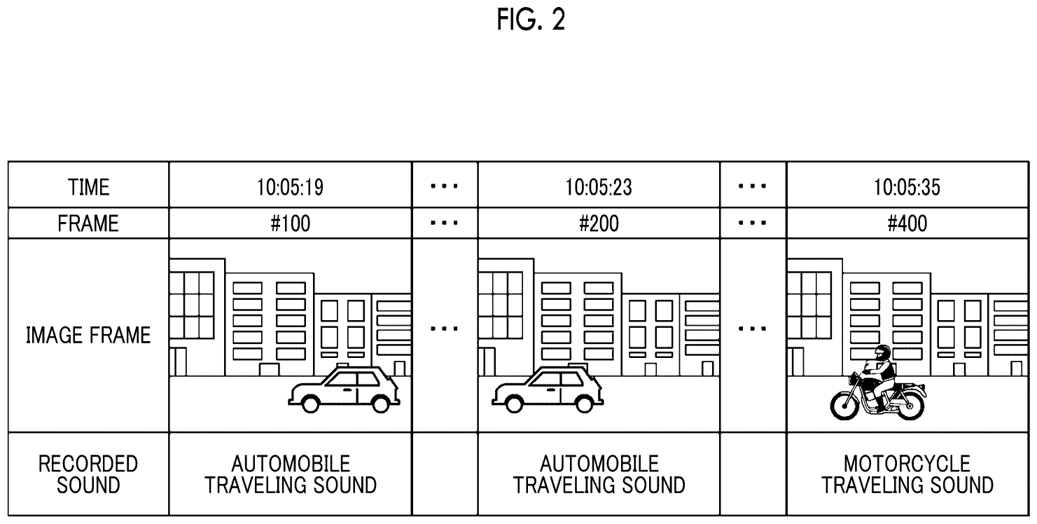

The video data is acquired by a known imaging apparatus such as a video camera and a digital camera. The imaging apparatus captures an image of a subject within an angle of view to create data of an image frame at a certain frame rate, and acquires video data consisting of a plurality of image frames as shown in FIG. 2. In one embodiment of the present invention, the subject recorded in each image frame includes a background (landscape).

It should be noted that, as shown in FIG. 2, a frame number (denoted by #n in the drawing; n is a natural number) is assigned to each image frame in the video data.

In one embodiment of the present invention, a situation in which a plurality of sound sources emit sounds is imaged to create the video data. Specifically, at least one sound source is recorded in each image frame included in the video data, and the plurality of sound sources are recorded in the entire video data. The sound source is a subject that emits a sound, and specifically, is an animal, a plant, an apparatus such as a machine, a device, an instrument, a tool, a siren, or an alarm bell, a vehicle, a natural object (environment) such as a mountain or a sea, an accident such as an explosion, and a natural phenomenon such as thunder or wind and rain. It should be noted that the sound source may include a person.

The sound data is data in which the sound is recorded, which corresponds to the video data. Specifically, the sound data includes the sounds emitted from the plurality of sound sources recorded in the video data. That is, the sound data is acquired by picking up the sound emitted from each sound source during the acquisition of the video data (that is, during the imaging) via a microphone built in or externally attached to the imaging apparatus. In one embodiment of the present invention, the sound included in the sound data is mainly a non-verbal sound, and is, for example, a machine operation sound, a vehicle sound, a natural sound such as a waterfall, a barking sound of an animal, an accident sound, a natural phenomenon sound, noise, and the like. In addition, the sound included in the sound data may include an emotional sound such as a laugh, a cry, or a surprised voice of a person, a sound generated due to a human action, and the like.

In one embodiment of the present invention, the video data and the sound data are synchronized with each other, and the acquisition of the video data and the acquisition of the sound data are started at the same timing and end at the same timing. That is, in one embodiment of the present invention, the video data corresponding to the sound data is acquired during the same period as the period in which the sound data is acquired.

The accessory information is information on the video data that can be recorded in a box region provided in the video file. The accessory information includes, for example, tag information in an exchangeable image file format (Exif) format, specifically, tag information on an imaging date and time, an imaging location, an imaging condition, and the like.

In addition, as shown in FIG. 1, the accessory information according to one embodiment of the present invention includes accessory information on a video recorded in the video data (hereinafter, accessory information on the video) and accessory information on the sound included in the sound data (hereinafter, accessory information on the sound). The accessory information on the video includes accessory information on a subject in the video (hereinafter, accessory information on the subject).

The accessory information will be described in detail in later.

The video file including the accessory information can be used, for example, as training data in machine learning for sound recognition. By this machine learning, it is possible to construct a learning model (hereinafter, a sound recognition model) that recognizes a sound in an input video and that outputs a recognition result of the sound.

In one embodiment of the present invention, the sound data included in the video file includes one or more non-verbal sounds. In this case, by executing the machine learning using the video file as the training data, it is possible to construct the sound recognition model for recognizing the non-verbal sound and identifying a type of the sound or the like.

<<Configuration Example of Information Creation Device According to One Embodiment of Present Invention>>

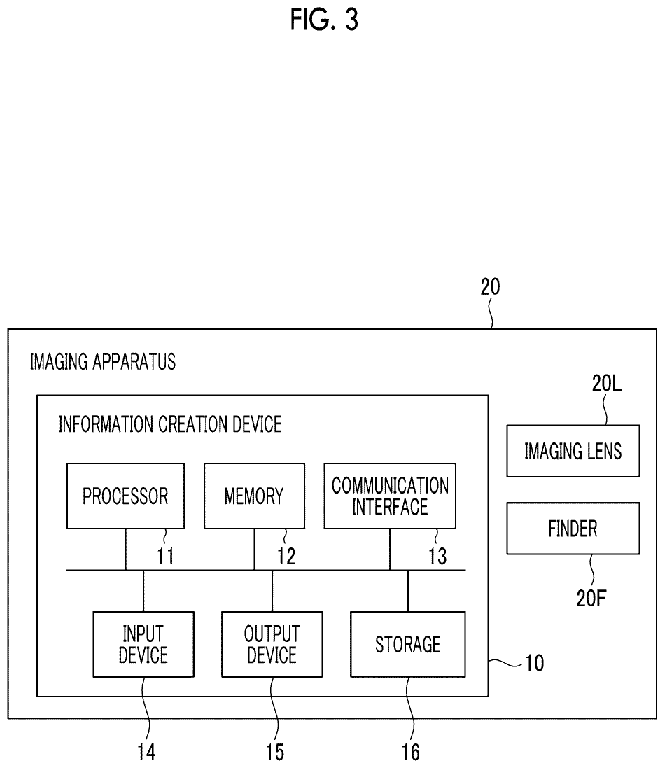

As shown in FIG. 3, the information creation device according to one embodiment of the present invention (hereinafter, an information creation device 10) comprises a processor 11, a memory 12, and a communication interface 13.

The processor 11 is configured by, for example, a central processing unit (CPU), a graphics processing unit (GPU), a digital signal processor (DSP), or a tensor processing unit (TPU).

The memory 12 is configured by, for example, semiconductor memories such as a read-only memory (ROM) and a random-access memory (RAM). The memory 12 stores a program for creating accessory information on the video data (hereinafter, an information creation program). The information creation program is a program for causing the processor 11 to execute the respective steps of the information creation method described later.

It should be noted that the information creation program may be acquired by being read from a computer-readable recording medium, or may be acquired by being downloaded via a communication network such as the Internet or an intranet.

The communication interface 13 is configured by, for example, a network interface card or a communication interface board. The information creation device 10 can communicate with another device via the communication interface 13 and can perform data transmission and reception with the device.

As shown in FIG. 3, the information creation device 10 further comprises an input device 14 and an output device 15. The input device 14 includes a device that receives a user operation, such as a touch panel and a cursor button, and a device that receives input of the sound, such as a microphone. The output device 15 includes a display device such as a display and an acoustic device such as a speaker.

The information creation device 10 can freely access various types of data stored in a storage 16. The data stored in the storage 16 includes data required for creating the accessory information. Specifically, data for specifying the sound source of the sound included in the sound data, data for identifying the subject recorded in the video data, and the like are stored in the storage 16.

It should be noted that the storage 16 may be built in or externally attached to the information creation device 10, or may be configured by a network-attached storage (NAS) or the like. Alternatively, the storage 16 may be an external device communicable with the information creation device 10 via the Internet or a mobile communication network, that is, for example, an online storage.

In one embodiment of the present invention, as shown in FIG. 3, the information creation device 10 is mounted in the imaging apparatus such as the video camera. A mechanical configuration of the imaging apparatus (hereinafter, referred to as an imaging apparatus 20) comprising the information creation device 10 is substantially the same as that of a known imaging apparatus having a function of acquiring the video data and the sound data. In addition, the imaging apparatus 20 comprises an internal clock and has a function of recording a time at each point in time during the imaging. As a result, the imaging time of each image frame of the video data can be specified and recorded.

It should be noted that the imaging apparatus 20 may be a portable imaging apparatus such as a digital camera, or may be an imaging apparatus that is used by being fixed at a predetermined position, such as a surveillance camera or a fixed-point camera.

The imaging apparatus 20 comprises an imaging lens 20L as shown in FIG. 3, images the subject within the angle of view via the imaging lens 20L, creates the image frame in which the subject is recorded at a certain frame rate, and acquires the video data. In addition, the imaging apparatus 20 acquires the sound data by picking up the sound emitted from the sound source in the periphery of the apparatus via the microphone or the like during the imaging. Further, the imaging apparatus 20 creates the accessory information based on the acquired video data and the acquired sound data, and creates the video file including the video data, the sound data, and the accessory information.

The imaging apparatus 20 may have an autofocus (AF) function of automatically focusing on a predetermined position within the angle of view and a function of specifying a focal position (AF point) during the imaging. The AF point is specified as a coordinate position in a case in which a reference position within the angle of view is set as an origin. The angle of view is a range in data processing in which the image is displayed or drawn, and the range is defined as a two-dimensional coordinate space with two axes orthogonal to each other as coordinate axes.

As shown in FIG. 3, the imaging apparatus 20 may comprise a finder 20F into which the user (that is, a person who captures an image) looks during the imaging. In this case, the imaging apparatus 20 may have a function of detecting a position of a gaze of the user and a position of a pupil of the user during the use of the finder, to specify a gaze position of the user. The gaze position of the user corresponds to a position of an intersection between the gaze of the user looking into the finder 20F and a display screen in the finder 20F.

The imaging apparatus 20 may be provided with a known distance sensor such as an infrared sensor, and, in this case, a distance (depth) of the subject within the angle of view in a depth direction can be measured by the distance sensor.

The imaging apparatus 20 may be provided with a sensor for a global positioning system (GPS) or a global navigation satellite system (GNSS). In this case, it is possible to measure the location (latitude and longitude) of the imaging apparatus 20 by using the function of the sensor.

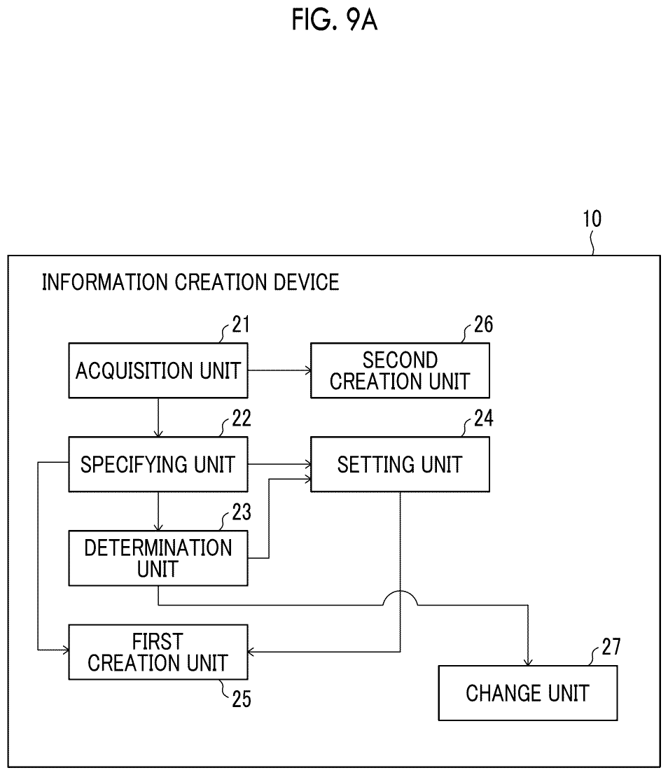

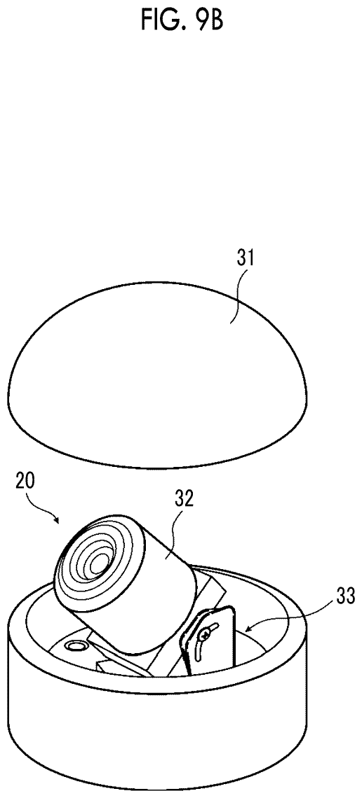

The imaging apparatus 20 may be used in a state of being supported by a pan-tilt head during the imaging (see FIG. 9B). The pan-tilt head may have a structure capable of changing a posture for supporting the imaging apparatus 20, and may comprise a mechanism for changing the posture and a control circuit of the mechanism. In this case, the imaging apparatus 20 may communicate with the control circuit via the communication interface 13 and control the posture of the pan-tilt head via the control circuit. As a result, during the imaging, the angle of view can be changed by changing an orientation of the imaging lens 20L based on an instruction signal from the imaging apparatus 20.

### <<Accessory Information>>

In one embodiment of the present invention, the accessory information on the video data is created by the functions of the information creation device 10 mounted in the imaging apparatus 20. The created accessory information is attached to the video data and the sound data to be a constituent element of the video file.

The accessory information is, for example, created in association with the image frame during a period in which the imaging apparatus 20 acquires the video data and the sound data (that is, during the imaging).

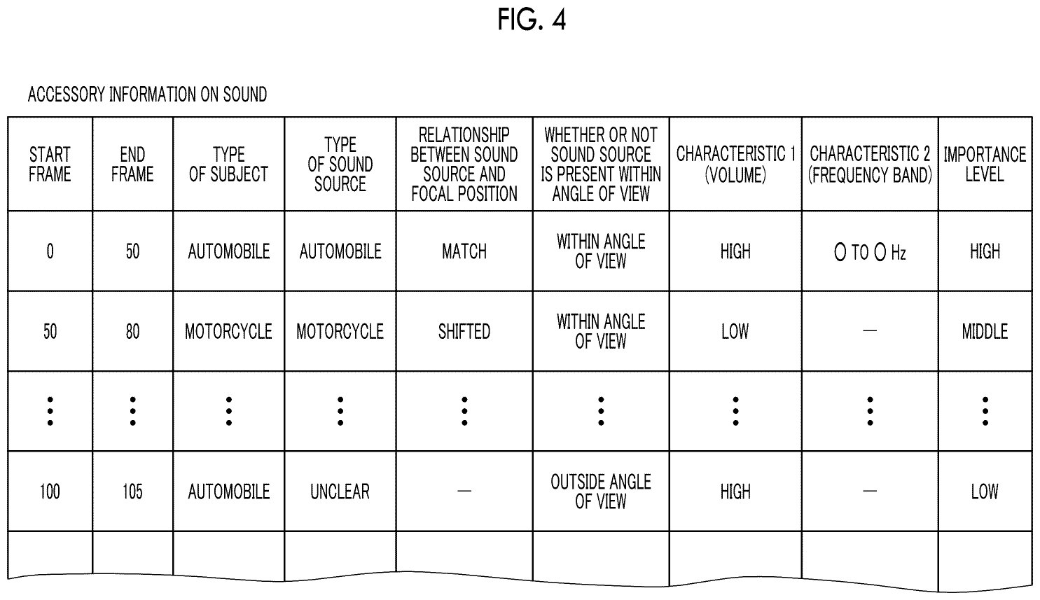

In one embodiment of the present invention, the accessory information on the subject is created based on the video data, and the accessory information on the sound is created based on the sound data. The accessory information on the subject and the accessory information on the sound are created in association with each other. Specifically, as shown in FIG. 4, each accessory information is created in association with two or more image frames among the plurality of image frames included in the video data. Specifically, the accessory information on the sound is created in association with two or more image frames captured during the sound generation. The accessory information on the subject is created in association with two or more image frames associated with the accessory information on the sound.

It should be noted that information on a correspondence relationship (hereinafter, correspondence information) between the accessory information on the sound and two or more image frames may be created as the accessory information. The correspondence information is information on time corresponding to each of a start point in time and an end point in time of the sound generation period or information on a frame number of the image frame captured at each of the start point in time and the end point in time, as shown in FIG. 4.

The accessory information on the subject is information on the subject present within the angle of view of the image frames constituting the video data, and includes, for example, information on a type of the subject as shown in FIG. 4. The type of the subject is a type based on a morphological attribute of the subject, and is specifically a general name of an object, an event, or the like.

The method of specifying the type of the subject is not particularly limited, and the type of the subject may be specified by a known subject recognition technology and a known image processing technology from characteristics of a region in which the subject is present in the image frame. Examples of the characteristics of the region in which the subject is present include hue, chroma saturation, brightness, a shape, a size, and a position in the angle of view of the region.

In addition, in a case in which the subject is the sound source and a predetermined condition is satisfied, mimetic word information in which a state of the subject, which is the sound source, is converted into text as a mimetic word is created as the accessory information on the subject. The mimetic word information is created by specifying the state of the subject via a known subject recognition technology and a known image processing technology from the characteristics of the region in which the subject is present in the image frame. The function of converting the state of the subject into text is realized by artificial intelligence (AI), specifically, a learning model that outputs the mimetic word in a case in which the state of the subject is input.

Here, the state of the subject that is converted into text as the mimetic word includes an appearance, a form (mode), a characteristic of a surface, a posture, a movement, an action, a state, a speed, a facial expression, and the like of the subject. In addition, the mimetic word includes words that imitatively express a state of a person or an object, specifically, a mimetic word expressing a movement or a state, a mimetic word (appearance-mimetic word) expressing an action or a mode, and a mimetic word (emotion-mimetic word) expressing a facial expression or a feeling.

In a case in which a plurality of subjects are present in the image frame, the accessory information on the subject may be created for each subject, or may be created for only some of the subjects (for example, a main subject).

The accessory information on the sound is information on the sound emitted from the sound source stored in the video data, and is particularly information on the non-verbal sound emitted from the sound source. The accessory information on the sound is created each time the sound source emits the sound. In other words, as shown in FIG. 4, the accessory information on the sound is created for each sound of the plurality of sounds emitted from the sound source and is included in the sound data.

As shown in FIG. 4, the accessory information on the sound includes characteristic information on the characteristics of the sound. Examples of the characteristics of the sound include nature and properties of the sound, an evaluation result for the sound, a language for expressing the content of the sound, an effect and an influence of the sound, and other items related to the sound. Specifically, a frequency of the sound, a dominant frequency (formant component), an amplitude, a volume (sound pressure), a waveform of the sound, text information in which the sound is converted into text, language (onomatopoeic word) mimicking the sound, and the like correspond to the characteristics of the sound.

In addition, the type of the sound and the type of the sound source correspond to the characteristics of the sound. The type of the sound represents what kind of sound it is, whether or not the sound is a noise sound, or what kind of scene the sound is from. The type of the sound source is a type based on a morphological attribute of the sound source, and is specifically a general name of an object, a person, or an event that emits the sound.

In one embodiment of the present invention, the characteristic information is created according to accuracy set for the sound or the sound source that emits the sound. The accuracy is the concept representing a degree of detail (detail level) of information to be created as the characteristic information. For the sound or the sound source for which higher accuracy is set, more detailed characteristic information is created, and, for example, the characteristic information on more items is created.

It should be noted that the concept of the accuracy can include selection of whether or not to create the characteristic information.

In addition, the accuracy is set according to an importance level of the sound or the sound source. The importance level may be represented by a stage, a rank, or the like, such as “high”, “medium”, and “low”, or may be represented by a numerical value.

The importance level of the sound is a degree of prominence of the sound, and specifically, is a degree to which the characteristics of the sound are prominent. The importance level of the sound is set based on the physical properties of the sound, such as the volume and the frequency, and the importance level is, for example, set to be higher as the volume becomes louder.

In addition, the importance level of the sound may be set based on the type of the sound. The type of the sound is the concept representing what kind of sound it is, and is, for example, whether the sound is a suddenly emitted sound such as a warning sound, an environmental sound, a noise sound, or a characteristic sound with a different quality, such as an explosion sound. It is preferable to set the importance level to be high for the characteristic sound and to set the importance level to be low for the noise sound or the environmental sound. With regard to the environmental sound, the sound source thereof may be the main subject (for example, a running sound of a train in a case of imaging the train), and, in such a case, the importance level may be set to be high even for the environmental sound.

It should be noted that, as a unit for specifying the type of the sound, AI for sound recognition may be used. In addition, the importance level of the sound may be set by AI for setting the importance level, that is, a learning model that outputs the importance level of the sound included in the sound data in a case in which the sound data is input.

The importance level of the sound source is a degree of influence exerted by the sound source on the video data, and is set based on, for example, the sound data and the video data. Specifically, the importance level of the sound source is set according to whether or not the sound source is present within the angle of view of the corresponding image frame. Specifically, since the sound source present as the subject within the angle of view is selected as an imaging target, the sound source is likely to be important to the user. In view of this point, a higher importance level is generally set for the sound source present within the angle of view or the sound emitted from the sound source.

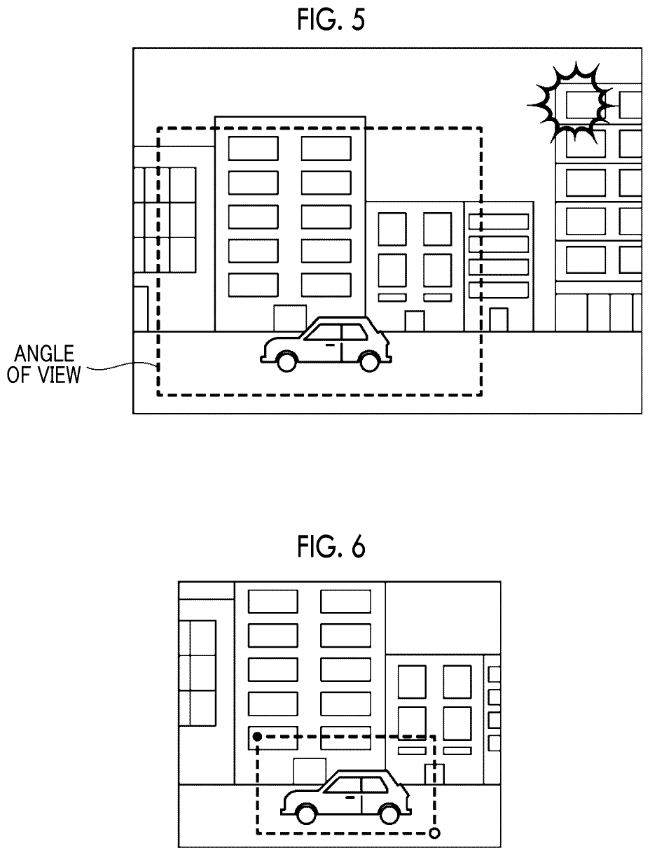

The method of determining whether or not the sound source is present within the angle of view will be described with reference to a case shown in FIG. 5 as an example. FIG. 5 shows a situation in which the explosion sound is generated outside the angle of view. In FIG. 5, a range surrounded by a dotted line represents an area of an angle of view (imaging angle of view).

In order to determine whether or not the sound source is present within the angle of view, first, the type of the sound is specified from the sound data. Thereafter, it is determined whether or not the sound source corresponding to the type of the sound is present among the subjects shown in the image frame at the point in time when the sound is generated in the video data. In the case of FIG. 5, since the sound source of the explosion sound (that is, an explosion point) is not recorded as the subject in the image frame, it is determined that the sound source is present outside the angle of view.

It should be noted that, in a pre-stage of specifying the type of the sound emitted from the sound data, it may be determined whether or not the subject (sound source) at a point in time when the sound is generated is present in the image frame.

The method of determining whether or not the sound source is present within the angle of view is not limited to the above-described method. For example, the position of the sound source may be specified by using a known sound source search technology, and whether or not the sound source is present within the angle of view may be determined from the specified position of the sound source. In this case, a directional microphone is used as a sound pickup microphone, and the position of the sound source is specified from a sound pickup direction of the directional microphone to determine whether or not the sound source is present within the angle of view. In addition, it is preferable that the directional microphone is a microphone that can combine a plurality of microphone elements to pick up sound over a wide range of 180° or more (preferably) 360° and determine a direction of each of the pickup sounds.

In a case in which the sound source is present within the angle of view of the image frame, the importance level of the sound source may be set based on a result of image recognition on the sound source in the image frame. Specifically, the importance level may be set based on the size of the sound source with respect to the angle of view, the type of the sound source, and the like. In this case, for example, the importance level may be set to be higher as the size becomes larger. In addition, in a case in which the sound source is a person, the importance level may be set to be relatively low, and in a case in which the sound source is an object, the importance level may be set to be relatively high. By setting the importance level of the sound source based on the result of the image recognition on the sound source in this way, the appropriateness of the set importance level is improved.

It should be noted that, as a unit for specifying the type of the sound source, AI for specifying the sound source may be used.

In addition, in a case in which the sound source is present within the angle of view of the image frame, the importance level of the sound source may be set based on apparatus information associated with the image frame for the imaging apparatus 20 that captures the image frame. The apparatus information is, for example, information on the focal position (AF point) of the imaging apparatus 20 in the image frame or information on the gaze position of the user of the imaging apparatus 20 in the image frame (specifically, the gaze position of the user detected by using a finder provided with a gaze detection sensor).

In a case of setting the importance level based on the apparatus information, a distance between the position of the sound source present within the angle of view and the focal position or a distance between the position of the sound source and the gaze position may be specified, and the importance level may be set to be higher as the distance becomes smaller. This setting reflects the tendency that the subject is more important to the user as the focal position or the gaze position becomes closer. By setting the importance level in this way based on the apparatus information of the imaging apparatus 20, the appropriateness of the set importance level is improved. In particular, in a case in which the focal position of the imaging apparatus 20 or the gaze position of the user is used as the apparatus information, a more appropriate importance level can be set for the above-described reason.

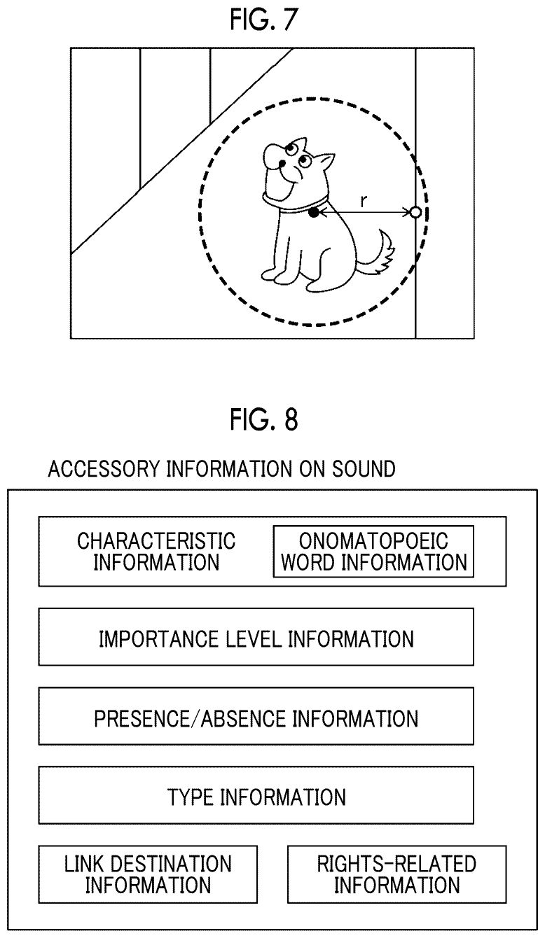

It should be noted that the method of specifying the position of the sound source present within the angle of view is not particularly limited, but, for example, as shown in FIG. 6, a region (hereinafter, a sound source region) surrounding a part or the entirety of the sound source is defined in the angle of view. In a case in which the sound source region is a rectangular region, coordinates of two intersections (points indicated by a white circle and a black circle in FIG. 6) located at both ends of a diagonal line at an edge of the region may be specified as the position (coordinate position) of the sound source. On the other hand, for example, in a case in which the sound source region is a circular region as shown in FIG. 7, the position of the sound source may be specified by the coordinates of the center (base point) of the region and a distance from the base point to the edge of the region (that is, a radius r). It should be noted that, even in a case in which the sound source region is a rectangular region, the position of the sound source may be specified by the coordinates of the center (intersection of the diagonal lines) of the region and the distance from the center to the edge.

In addition, in a case in which the importance level is set based on the position of the sound source, the importance level may be set based on both the position of the sound source and the distance with reference to the distance (depth) of the sound source.

In addition, in a case in which the sound source is present outside the angle of view of the image frame, the importance level of the sound source may be set based on a scene of a video, an event, or the like recorded in the video data. Specifically, an important scene or event may be recognized based on the video data, and the importance level may be set based on the relevance between the recognized scene or event and the sound emitted by the sound source that is present outside the angle of view. For example, in a case in which a scene of a “festival” is recorded in the video data, in a case in which a drum sound of the festival is recorded in the sound data and the drum, which is the sound source, is present outside the angle of view, the importance level of the sound source (drum) is set to be relatively high. In addition, in the scene shown in FIG. 5, for a distinctive sound such as the explosion sound, even in a case in which the sound source is present outside the angle of view, the importance level of the explosion sound is set to be relatively high.

It should be noted that, in a case of recognizing the scene, the event, or the like, a sensor for GPS provided in the imaging apparatus 20 may be used to specify the location of the imaging apparatus 20, and the scene, the event, or the like may be determined based on the location.

The method of setting the importance level is not limited to the above-described method, and, for example, the importance level of the sound or the sound source may be designated by the user. As a result, the user's intention can be reflected in the accessory information on the sound, more specifically, the accuracy in a case of creating the accessory information.

In a case in which the importance level of the sound or the sound source is set in the above-described manner, the accuracy according to the importance level is set for the sound or the sound source. Specifically, higher accuracy is set as the importance level becomes higher. Then, for the sound or the sound source for which the accuracy is set, the characteristic information on the sound is created according to the accuracy. For example, the characteristic information is created with higher accuracy for the sound having a higher importance level. On the contrary, the characteristic information is created with lower accuracy for the sound having a lower importance level. As a result, it is possible to create the characteristic information more efficiently than in a case of creating the characteristic information with a unified detail level or information amount for each of the plurality of sounds included in the sound data.

Since the characteristic information is created as the accessory information, the characteristic information can be used in a case in which the machine learning is executed by using the video file including the accessory information as the training data. Specifically, in a case in which the video file is sorted (annotated) as the training data, the characteristic information included in the video file can be used.

By setting the accuracy for the sound included in the sound data or the sound source thereof, or creating the characteristic information according to the accuracy, it is possible to more appropriately sort the video file. That is, in a case in which the characteristic information according to the accuracy is created for the sound included in the sound data, for example, more detailed characteristic information is created for the important sound, and thus the annotation can be performed based on the characteristic information.

In addition, as shown in FIG. 4, the importance level information on the importance level set for the sound or the sound source may be created as the accessory information on the sound. In this case, in a case in which the machine learning is executed by using the video file as the training data, the importance level information as the accessory information included in the video file can be used. Specifically, in a case of executing the machine learning, the data of the sound having a higher importance level can be extracted based on the importance level information, and the machine learning can be executed using the characteristic information of the sound or the like.

In addition, in a case in which the position and the distance (depth) of the sound source are specified in a case of setting the importance level for the sound source, information on the position and the distance (depth) of the sound source may be further created as the accessory information on the sound.

It may be determined whether or not the sound source of the sound included in the sound data is present within the angle of view of the image frame corresponding to the sound, and information (hereinafter, presence/absence information) on a determination result may be further created as the accessory information on the sound as shown in FIG. 4. In such a case, the video file to be used as the training data can be sorted (annotated) based on the presence/absence information included in the video file.

In addition, as shown in FIG. 4, information (hereinafter, type information) on the type of the sound source of the sound included in the sound data may be created as the accessory information on the sound. In such a case, a desired video file can be searched for based on the type information included as the accessory information in the video file. That is, the type information as the accessory information can be used as a search key in a case of searching for the video file.

In addition, as shown in FIG. 8, for the sound or the sound source having a high importance level, onomatopoeia word information in which the sound is converted into text as an onomatopoeia word may be created as the accessory information on the sound (specifically, one of these pieces of characteristic information described above). The onomatopoeic word information is created by applying a known sound recognition technology to the sound (non-verbal sound) included in the sound data and assigning a plausible word based on the pronunciation of the sound. The function of converting the sound into text is realized by artificial intelligence (AI), specifically, a learning model that outputs the onomatopoeic word in a case in which the sound is input.

It should be noted that the onomatopoeic word includes onomatopoeic words (words expressed by imitating a voice) such as a laugh of a person and a barking sound of an animal.

By creating the onomatopoeia word information in which the non-verbal sound is converted into text as the accessory information, the usefulness of the video file is further improved. That is, by executing the machine learning using the video file including the onomatopoeia word information as the training data, a relationship between the non-verbal sound and the onomatopoeic word information can be learned, and a more accurate sound recognition model can be constructed.

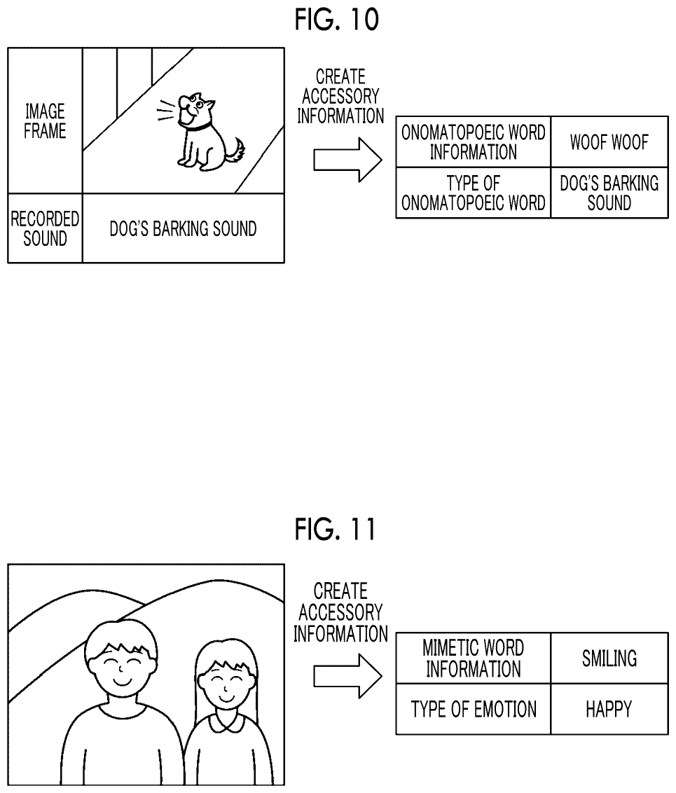

In addition, in a case of creating the onomatopoeia word information, information on the type of the onomatopoeic word (for example, whether the onomatopoeic word is a laugh of a person, a barking sound of an animal, or the like) may be created together (see FIG. 10). It should be noted that, for the sound or the sound source having a low importance level, the onomatopoeia word information need not be created from the viewpoint of reducing the load, but the present invention is not limited to this, and the onomatopoeia word information may be created.

In one embodiment of the present invention, as shown in FIG. 8, the accessory information on the sound may further include link destination information and rights-related information.

The link destination information is information indicating a link to a storage destination (save destination) of the voice file in a case in which the same sound data as the sound data of the video file is created as a separate file (voice file). It should be noted that, since the sounds emitted from the plurality of sound sources are recorded in the sound data of the video file, the voice file may be created for each sound source. In this case, the link destination information is created as the accessory information for each voice file (that is, for each sound source).

The rights-related information is information on the attribution of a right related to the sound included in the sound data and the attribution of a right related to the video data. For example, in a case in which a scene in which a plurality of performers take turns playing is imaged to create the video file, the right (copyright) of the video data belongs to a creator of the video file (that is, a person who captures an image). On the other hand, a right related to the sound (performance sound) of each of the plurality of performers recorded in the sound data belongs to each performer, an organization to which the performer belongs, or the like. In this case, the rights-related information that defines the attribution relationship of these rights is created as the accessory information.

### <<Function of Information Creation Device>>

The functions of the information creation device 10 according to one embodiment of the present invention (hereinafter, a first embodiment) will be described with reference to FIG. 9A.

As shown in FIG. 9A, the information creation device 10 according to the first embodiment includes an acquisition unit 21, a specifying unit 22, a determination unit 23, a setting unit 24, a first creation unit 25, a second creation unit 26, and a change unit 27. These functional units are realized by the hardware devices (processor 11, memory 12, communication interface 13, input device 14, output device 15, and storage 16) of the information creation device 10 and the software including the above-described information creation program in cooperation with each other. Some functions are realized by using artificial intelligence (AI). Hereinafter, the respective functional units will be described.

### (Acquisition Unit)

The acquisition unit 21 controls each unit of the imaging apparatus 20 to acquire the video data and the sound data. In the first embodiment, the acquisition unit 21 simultaneously creates the video data and the sound data while synchronizing the video data and the sound data with each other during a period in which the plurality of sound sources emit the sounds (non-verbal sounds). Specifically, the acquisition unit 21 acquires the video data consisting of the plurality of image frames such that at least one sound source is recorded in one image frame. In addition, the acquisition unit 21 acquires the sound data including the plurality of sounds emitted from the plurality of sound sources recorded in the plurality of image frames included in the video data. In this case, each sound is associated with two or more image frames acquired during the sound generation period among the plurality of image frames (for example, see FIG. 4).

### (Specifying Unit)

The specifying unit 22 specifies the content related to the sound included in the sound data, based on the video data and the sound data acquired by the acquisition unit 21.

Specifically, the specifying unit 22 specifies the correspondence relationship between the sound and the image frame for each of the plurality of sounds included in the sound data, and more specifically, specifies two or more image frames acquired in each sound generation period.

In addition, the specifying unit 22 specifies the characteristics (volume, sound pressure, amplitude, frequency, sound type, and the like) and the sound source for each sound.

Further, the specifying unit 22 specifies whether or not the sound source of the sound is present within the angle of view of the corresponding image frame. Here, the corresponding image frame is an image frame captured at a point in time when the sound is emitted from the sound source among the plurality of image frames included in the video data.

In a case in which the sound source is present within the angle of view, the specifying unit 22 specifies the position and the distance (depth) of the sound source present within the angle of view. In this case, the specifying unit 22 recognizes the image (specifically, the sound source region) related to the sound source in the corresponding image frame, and specifies the size of the sound source, the type of the sound source, and the like as the result of the image recognition. Further, the specifying unit 22 acquires the apparatus information on the focal position (AF point) of the imaging apparatus 20 in the corresponding image frame or the gaze position of the user in the corresponding image frame, and specifies the distance (interval) between these positions and the position of the sound source.

### (Determination Unit)

In a case in which the sound source is not present within the angle of view of the corresponding image frame, the determination unit 23 determines whether or not the sound emitted from the sound source satisfies a predetermined criterion (hereinafter, a determination criterion) based on the characteristics specified by the specifying unit 22. The determination criterion is a criterion set for the sound emitted from the sound source present outside the angle of view, and is, for example, whether or not the volume is equal to or higher than a certain level, whether or not the sound is in a specific frequency band, whether or not the sound is a characteristic sound with a different quality, and the like.

It should be noted that the determination criterion may be set in advance on the imaging apparatus 20 side, or may be set by the user.

### (Setting Unit)

The setting unit 24 sets the importance level for each of the plurality of sounds emitted from the plurality of sound sources and included in the sound data or for each of the sound sources of the respective sounds.

In a case in which the importance level is set for the sound source, the setting unit 24 sets the importance level based on whether or not the sound source is present within the angle of view of the corresponding image frame.

In addition, in a case in which the sound source is present within the angle of view, the setting unit 24 sets the importance level of the sound source based on the result of the image recognition related to the sound source in the image frame, that is, the size of the sound source and the type of the sound source which are specified by the specifying unit 22.

Further, in a case in which the sound source is present within the angle of view, the setting unit 24 may specify the focal position of the imaging apparatus 20 or the gaze position of the user from the apparatus information, and may set the importance level of the sound source based on the distance between the specified position and the position of the sound source.

In addition, in a case in which the sound source is not present within the angle of view, the setting unit 24 sets the importance level for the sound emitted from the sound source based on the determination result of the determination unit 23. Specifically, the setting unit 24 sets, for example, a higher importance level for the sound that satisfies the determination criterion than for the sound that does not satisfy the determination criterion. The sound emitted from the sound source present outside the angle of view is generally set to have a low importance level, but in a case in which the characteristic sound such as the explosion sound satisfies the determination criterion, the sound may be important to the user even though the sound is emitted from the sound source present outside the angle of view. In the first embodiment, in consideration of this point, the importance level can be appropriately set for the sound emitted from the sound source present outside the angle of view, according to whether or not the determination criterion is satisfied.

The setting unit 24 sets the accuracy for each sound or sound source according to the set importance level. Specifically, higher accuracy is set for the sound or the sound source for which a higher importance level is set, and lower accuracy is set for the sound or the sound source for which a lower importance level is set.

### (First Creation Unit)

The first creation unit 25 creates the characteristic information based on the characteristics specified by the specifying unit 22 for each of the plurality of sounds emitted from the plurality of sound sources and included in the sound data. In this case, the first creation unit 25 creates the characteristic information based on the accuracy set by the setting unit 24 for the sound or the sound source, and specifically, creates the characteristic information with the degree of detail (detail level) according to the accuracy.

In addition, based on the correspondence relationship between the sound specified by the specifying unit 22 and the image frame, the first creation unit 25 creates the correspondence information on the correspondence relationship.

In addition, the first creation unit 25 creates the importance level information on the importance level set by the setting unit 24 for the sound or the sound source as the accessory information on the sound, for each of the plurality of sounds emitted from the plurality of sound sources and included in the sound data.

In addition, in a case in which the specifying unit 22 specifies whether or not the sound source is present within the angle of view of the corresponding image frame, the first creation unit 25 further creates the presence/absence information on the presence or absence of the sound source within the angle of view as the accessory information on the sound.

In addition, in a case in which the type of the sound source present within the angle of view is specified by the specifying unit 22, the first creation unit 25 further creates the type information on the type of the sound source as the accessory information on the sound.

In addition, in a case in which the accuracy set according to the importance level of the sound or the sound source satisfies a predetermined condition (hereinafter, referred to as a first condition), the first creation unit 25 can create the onomatopoeia word information in which the sound is converted into text as the onomatopoeia word, as the accessory information on the sound. For example, as shown in FIG. 10, in a case in which the sound included in the sound data is a dog's barking sound and the accuracy set according to the importance level of the sound satisfies the first condition, the first creation unit 25 creates the onomatopoeia word information “woof woof”. In this case, as shown in FIG. 10, the first creation unit 25 may create the accessory information on the type of the onomatopoeic word together.

The first condition corresponds to the accuracy with which the onomatopoeic word information is to be created, and is, for example, the accuracy corresponding to the importance level equal to or higher than a certain level.

It should be noted that the sound may include a sound that continues for a long time, such as rain sound, or a sound that is repeated for a certain time, such as a siren. It is not necessary to create the onomatopoeia word information for the entire sound generation period for such a sound, and, for example, the onomatopoeic word information may be created at a certain interval (specifically, a frequency of once every several hundred frames). That is, the frequency of creating the accessory information may be changed according to the type of the sound (non-verbal sound).

### (Second Creation Unit)

The second creation unit 26 creates the accessory information (accessory information on the subject) for the subject present within the angle of view of the image frame included in the video data. In the first embodiment, in a case in which the accuracy according to the importance level set for the sound or the sound source satisfies a predetermined condition (hereinafter, referred to as a second condition), the second creation unit 26 creates the mimetic word information for the sound source of the sound. The mimetic word information is information on a state of the sound source in the corresponding image frame. For example, as shown in FIG. 11, in a case in which the sound source present within the angle of view is a person who is smiling, and the accuracy set according to the importance level of the sound satisfies the second condition, the second creation unit 26 creates the mimetic word information of “smiling”. In this case, as shown in FIG. 11, the second creation unit 26 may create the accessory information on the type of the emotion of the person converted into text as the mimetic word.

It should be noted that, as the method of creating the mimetic word information for the state of the sound source, for example, the state of the sound source may be specified from the video using a known image analysis technology, and the mimetic word corresponding to the specified state may be assigned by AI.

The second condition corresponds to the accuracy with which the mimetic word information is to be created, and is, for example, the accuracy corresponding to the importance level equal to or higher than a certain level. The sound source having the accuracy satisfying the second condition may be, for example, the main subject in the corresponding image frame. The main subject corresponds to a subject having the largest size in the image frame, a subject closest to the focal position or the gaze position of the user, or the like.

As described above, with the function of the second creation unit 26, it is possible to create the mimetic word information representing the state of the sound source in the language (mimetic word) as the accessory information. As a result, the usefulness of the video file is further improved. Specifically, by executing the machine learning using the video file including the mimetic word information as the training data, it is possible to construct a learning model that, in a case in which the video of the subject (specifically, the sound source) is input, outputs the mimetic word based on the video.

In addition, in a case in which the sound source moves, the second creation unit 26 may detect the movement of the sound source from the video shown by the video data, and may create the mimetic word information representing the movement as the accessory information. In particular, it is preferable to create the mimetic word information in a case in which the movement of the sound source satisfies a predetermined condition, for example, in a case in which the sound source, which is the subject, moves significantly in the video.

### (Change Unit)

The change unit 27 changes the orientation of the imaging lens 20L of the imaging apparatus 20 by controlling the pan-tilt head or changes the zoom magnification of the imaging apparatus 20. Specifically, in a case in which the sound source is not present within the angle of view of the corresponding image frame, the determination unit 23 determines whether or not the sound emitted from the sound source satisfies the determination criterion, as described above. Then, in a case in which the sound satisfies the determination criterion, the change unit 27 changes the orientation of the imaging lens 20L such that the imaging lens 20L approaches a direction of the sound source (that is, such that the imaging lens 20L faces the sound source). Alternatively, the change unit 27 reduces the zoom magnification of the imaging apparatus 20 such that the sound source is included in the angle of view of the image frame.

It should be noted that the pan-tilt head is not particularly limited as long as the pan-tilt head has a structure capable of changing the orientation of the imaging lens 20L, and a pan-tilt head 33 is shown as an example in FIG. 9B. The pan-tilt head 33 is a three-axis moving mechanism capable of moving a housing 32 accommodating a body of the imaging apparatus 20 in three axial directions (roll, pitch, and yaw directions). The configurations of the housing 32 and the pan-tilt head 33, which is the three-axis moving mechanism, are known configurations, and the imaging apparatus 20, the housing 32, and the pan-tilt head 33 may be covered with a dome-shaped cover 31 as shown in FIG. 9B.

With the function of the change unit 27, in a case in which the characteristic sound such as the explosion sound is generated and the sound source thereof is not present within the angle of view, the angle of view can be changed so as to include the sound source in the corresponding image frame. As a result, the video of the sound source (sound generation location) can be recorded for the characteristic sound generated outside the angle of view.

It should be noted that the orientation and the zoom magnification (in other words, the angle of view after the change) of the imaging lens 20L changed by the change unit 27 are maintained for a predetermined period of time, specifically, for a period during which the sound satisfying the determination criterion is generated. The orientation and the zoom magnification of the imaging lens 20L may be restored to the setting content before the change after being maintained for the predetermined period of time with the changed setting content.

### <<Information Creation Flow According to One Embodiment of Present Invention>>

Hereinafter, an information creation flow using the information creation device 10 will be described. In the information creation flow to be described later, the information creation method according to the embodiment of the present invention is used. That is, each step in the information creation flow described later corresponds to a constituent element of the information creation method according to the embodiment of the present invention.

It should be noted that the following flow is merely an example, and unnecessary steps in the flow may be deleted, new steps may be added to the flow, or the execution order of two steps in the flow may be exchanged within a range not departing from the gist of the present invention.

Each step in the information creation flow is executed by the processor 11 provided in the information creation device 10. That is, in each step in the information creation flow, the processor 11 executes processing corresponding to each step in the data processing defined by the information creation program.

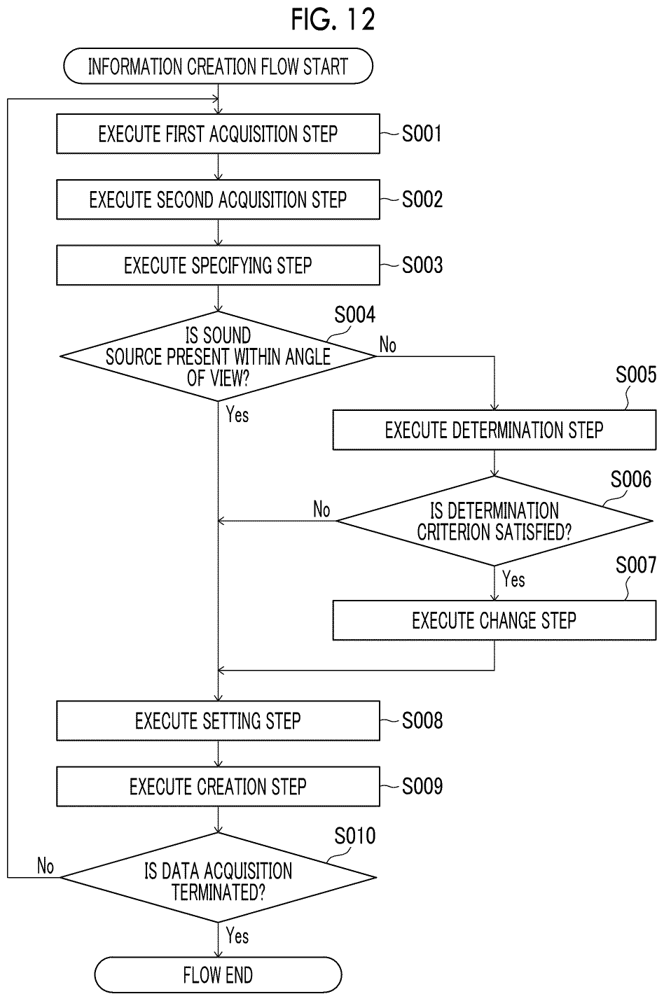

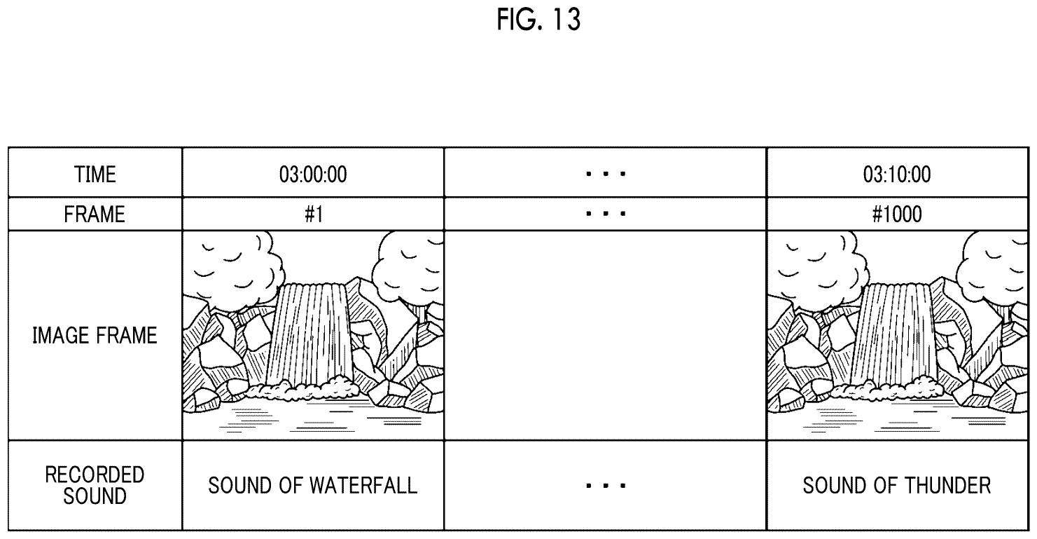

The information creation flow according to the first embodiment proceeds according to a flow shown in FIG. 12. In the present flow, the video data and the sound data are acquired, and the accessory information on the video data is created to create the video file.

In the information creation flow, the processor 11 executes a first acquisition step (S001) of acquiring the sound data including the plurality of sounds emitted from the plurality of sound sources and a second acquisition step (S002) of acquiring the video data including the plurality of image frames.

It should be noted that, in the flow shown in FIG. 12, the second acquisition step is executed after the first acquisition step, but, for example, in a case in which the video with sound is captured by using the imaging apparatus 20, the first acquisition step and the second acquisition step are executed at the same time.

During the execution period of the first acquisition step and the second acquisition step, the processor 11 executes a specifying step (S003). In the specifying step, the content related to the sound included in the sound data is specified, and specifically, the correspondence relationship between the sound and the image frame, the characteristics of the sound, the type of the sound, the sound source, and the like are specified.

In the specifying step, it is specified whether or not the sound source of the sound is present within the angle of view of the corresponding image frame. For the sound source present within the angle of view, the position and the distance (depth) of the sound source within the angle of view, the size of the sound source, the type of the sound source, and the like are further specified.

In a case in which the sound source is present within the angle of view, the apparatus information on the focal position (AF point) of the imaging apparatus 20 in the corresponding image frame or the gaze position of the user in the corresponding image frame is acquired, and the distance between the position indicated by the apparatus information and the position of the sound source is specified.

In a case in which it is specified in the specifying step that the sound source is present within the angle of view of the corresponding image frame (Yes in S004), the processor 11 proceeds to a setting step (S008).

On the other hand, in a case in which the sound source is not present within the angle of view of the corresponding image frame (No in S004), the processor 11 executes a determination step (S005). In the determination step, it is determined whether or not the sound emitted from the sound source present outside the angle of view satisfies the determination criterion based on the characteristics specified in the specifying step.

In a case in which the sound satisfies the determination criterion (Yes in S006), the processor 11 executes a change step (S007). In the change step, the orientation of the imaging lens 20L is changed such that the imaging lens 20L of the imaging apparatus 20 approaches the direction of the sound source, or the zoom magnification of the imaging apparatus 20 is reduced such that the sound source is included in the angle of view of the image frame.

After the change step is executed, the processor 11 proceeds to the setting step (S008).

In the setting step, the processor 11 sets the importance level for each of the plurality of sounds emitted from the plurality of sound sources and included in the sound data or for the sound source of each sound.

The importance level is set based on the presence or absence of the sound source within the angle of view of the corresponding image frame. In addition, for the sound source present within the angle of view, the importance level is set based on the result of the image recognition on the sound source in the image frame (specifically, the size of the sound source, the type of the sound source, and the like). Further, for the sound source present within the angle of view, the importance level is set based on the distance between the focal position of the imaging apparatus 20 or the gaze position of the user, which is specified from the apparatus information, and the position of the sound source.

For the sound source that is not present within the angle of view, the importance level is set based on the determination result in the determination step, and a higher importance level is set in a case in which the determination criterion is satisfied than in a case in which the determination criterion is not satisfied.

In the setting step, the accuracy is set according to the set importance level for each sound or sound source. Here, as described above, the importance level of the sound source present within the angle of view is set based on whether or not the sound source is present within the angle of view of the corresponding image frame. Therefore, for the sound source present within the angle of view, the accuracy is set based on the presence or absence of the sound source within the angle of view.

In addition, for the sound source present within the angle of view, the importance level is set based on the result of the image recognition on the sound source in the corresponding image frame and the focal position or the gaze position of the user, which is indicated by the apparatus information. Therefore, for the sound source present within the angle of view, the accuracy is set based on the result of the image recognition on the sound source and the apparatus information.

On the other hand, for the sound source that is not within the angle of view, the importance level is set based on whether or not the sound satisfies the determination criterion, and thus the accuracy is set for the sound emitted from the sound source present outside the angle of view based on whether or not the determination criterion is satisfied. In this case, the accuracy for the sound is set to be higher in a case in which the determination criterion is satisfied than in a case in which the predetermined criterion is not satisfied.

The flow up to this point will be specifically described with reference to a case shown in FIG. 13 as an example. In the case shown in FIG. 13, the video is captured with a waterfall as the subject, and thunder occurs outside the angle of view at a certain point in time after the start of the imaging (at a point in time corresponding to #1000 in the frame number). Therefore, the sound data acquired during the video capturing includes a sound of the waterfall and a sound of the thunder. The sound of the waterfall corresponds to the image frames from #1 to #999 in the video. Meanwhile, the sound of the thunder corresponds to the image frame #1000 captured at the point in time of the occurrence of the thunder.

For example, as shown in FIG. 13, the sound source of the sound of the waterfall, that is, the waterfall, is present within the angle of view of the corresponding image frame in a period corresponding to the frame numbers from #1 to #999. Therefore, the importance level of the waterfall as the sound source is set based on the size of the waterfall within the angle of view, the distance between the focal position of the imaging apparatus or the gaze position of the user and the waterfall, and the like. In the case shown in FIG. 13, since the size of the waterfall is larger than a reference size, the waterfall corresponds to the main subject, and thus the importance level of the waterfall is set to be relatively high. As a result, the accuracy for the waterfall is set to be relatively high according to the importance level.

On the other hand, the sound source of the sound of the thunder, that is, the thunder, is present outside the angle of view of the corresponding image frame at a point in time corresponding to the frame number #1000. Therefore, in the determination step, it is determined whether or not the sound of the thunder satisfies the determination criterion, for example, whether or not the volume of the sound of the thunder is equal to or greater than a reference value. In the case shown in FIG. 13, the sound of the thunder does not satisfy the determination criterion, and thus the importance level of the sound of the thunder is set to be relatively low. As a result, the accuracy for the thunder is set to be relatively low according to the importance level.

It should be noted that the importance level and the accuracy are set to be higher in a case in which the sound of the thunder satisfies the determination criterion than in a case in which the sound of the thunder does not satisfy the determination criterion. Further, in this case, the change step is executed, and the orientation or the zoom magnification of the imaging lens 20L is changed such that the thunder as the sound source is located within the angle of view from outside the angle of view.

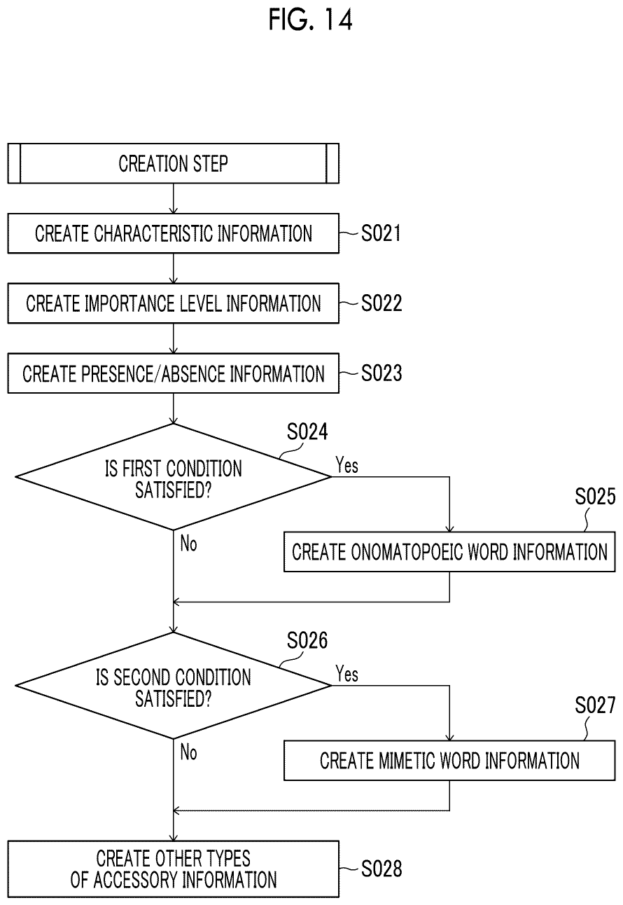

Returning to the description of the information creation flow, after the setting step is executed, the processor 11 executes a creation step (S009) of creating the accessory information on the video data. The creation step proceeds according to a flow shown in FIG. 14. In the creation step, as the accessory information on the video data, the accessory information on the sound and the accessory information on the video are created.

The accessory information on the sound is created based on the content specified in the specifying step. Specifically, in the creation step, a step (S021) of creating the characteristic information for each of the plurality of sounds emitted from the plurality of sound sources and included in the sound data is executed. In step S021, the characteristic information is created based on the accuracy set in the setting step. That is, in a case in which the accuracy for the sound or the sound source is set to be relatively high, more detailed characteristic information is created for the sound. On the other hand, in a case in which the accuracy is set to be relatively low for the sound or the sound source, the characteristic information is created with lower detail level for the sound, or the creation of the characteristic information is omitted.

In the creation step, a step (S022) of creating the importance level information on the importance level of the sound or the sound source set in the setting step as the accessory information is also executed.

Further, in the creation step, a step (S023) of creating the presence/absence information on whether or not the sound source is present within the angle of view of the corresponding image frame as the accessory information is executed.

In addition, in a case in which the accuracy set according to the importance level of the sound or the sound source satisfies the first condition (S024), a step (S025) of creating the onomatopoeia word information in which the sound is converted into text as the onomatopoeia word as the accessory information is executed.

In addition, in a case in which the accuracy according to the importance level set for the sound source present within the angle of view of the image frame satisfies the second condition (S026), a step (S027) of creating the mimetic word information in which the state of the sound source is converted into text as the mimetic word as the accessory information is executed. In the creation step, the other types of accessory information (specifically, the correspondence information, the type information, and the like) are also created (S028).

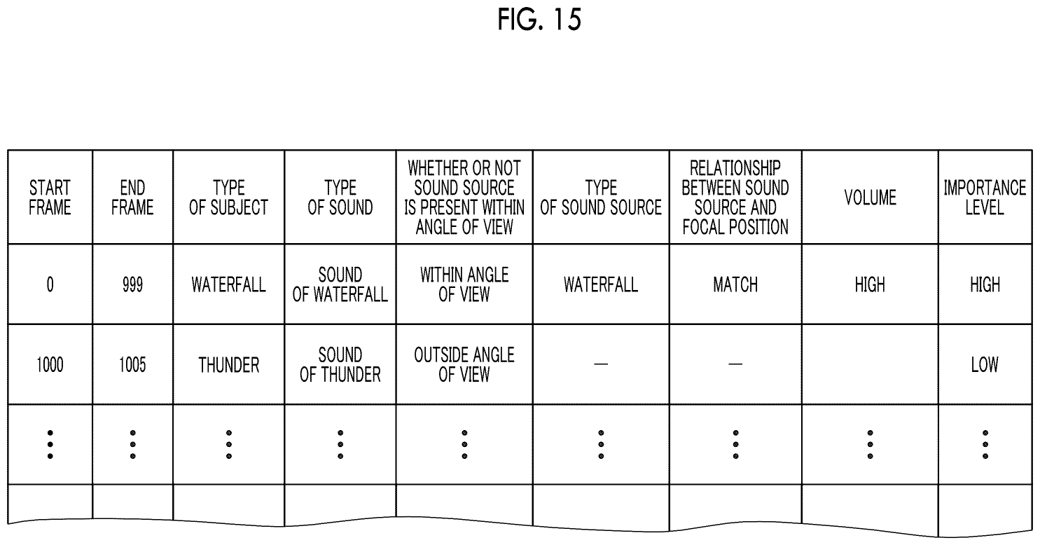

Steps S001 to S009 in the information creation flow are repeatedly executed during the period in which the video data and the sound data are acquired (that is, during the video capturing). As a result, as shown in FIG. 15, the accessory information on the sound is created for each of the plurality of sounds emitted from the plurality of sound sources and included in the sound data. FIG. 15 shows the accessory information on the sound created for the case of FIG. 13.

As shown in FIG. 15, for the “sound of the waterfall” corresponding to the image frames from #1 to #999, the importance level is set to be higher for the waterfall that is the sound source. Therefore, for the “sound of the waterfall”, as shown in FIG. 15, the characteristic information is created with higher accuracy, and specifically, the information on the volume, the type of the sound source, the positional relationship between the sound source and the focal position, or the like is created as the characteristic information.

On the other hand, the importance level is set to be lower for the “sound of the thunder” corresponding to the image frame of #1000. Therefore, for the “sound of the thunder”, as shown in FIG. 15, the accuracy in a case of creating the characteristic information is lower, and the information indicating the type of the sound is created, while the characteristic information on the volume, the type of the sound source, and the like is not created.

In a case in which the acquisition of these pieces of data ends (S010), the information creation flow ends.

### <<Second Embodiment of Present Invention>>

In some cases, an abnormality in an inspection target is inspected by using a sound, as in a tapping sound inspection. In a case of acquiring the video data and the sound data of the inspection to create the video file, information on an inspection result based on the sound may be created as the accessory information on the sound. A configuration will be adopted as a second embodiment of the present invention, and the second embodiment will be described hereinafter.

It should be noted that, in the following description, a difference of the second embodiment from the first embodiment will be mainly described.

In the second embodiment, the plurality of sounds included in the sound data include sounds emitted from a plurality of inspection targets during the inspection. That is, in the second embodiment, the plurality of inspection targets are included in the plurality of sound sources. The plurality of inspection targets may be a plurality of inspection target articles or a plurality of inspection points set on one object (including a structure such as a building).

Hereinafter, as an example, a case will be described in which the tapping sound inspection is performed on the plurality of inspection target articles (products).

It should be noted that, in the tapping sound inspection, each of the plurality of inspection target articles is transported to an inspection point one by one, and the tapping sound inspection is performed at the inspection point.

A state of the tapping sound inspection is imaged by the imaging apparatus 20 comprising the information creation device 10, and the sound generated during the inspection is picked up by the microphone provided in the imaging apparatus 20. As a result, the video data and the sound data for the sound of the tapping sound inspection are acquired. The sound data includes the plurality of sounds, and the plurality of sounds include an inspection sound and a transport sound. The inspection sound is a sound emitted from the inspection target article to which an impact for inspection is applied at the inspection point. The transport sound is an operation sound in a case in which a transport device (not shown) operates to exchange the inspection target article disposed at the inspection point.

The information creation device 10 can specify the inspection target article that is disposed at the inspection point and that undergoes the inspection. Specifically, a storage element in which identification information (ID) is stored is attached to each inspection target, and a sensor (not shown) reads the identification information from the storage element of the inspection target article disposed at the inspection point. The information creation device 10 obtains the identification information read by the sensor by communicating with the sensor via the communication interface 13. As a result, the ID of the inspection target article during the inspection is specified by the information creation device 10.

It should be noted that, in a case in which the inspection target articles are disposed at different places, a disposition position of the inspection target article may be specified by using a GPS function or the like, thereby specifying each inspection target article. In addition, in a case in which the inspection target article has the identification information on a surface thereof, the identification information may be recognized by using an image authentication technology of the imaging apparatus 20, and each inspection target article may be specified from the identification information.

The information creation device 10 creates the accessory information on the sound for each of the inspection sound and the transport sound included in the sound data. Specifically, the information creation device 10 sets the importance level for each of the inspection sound and the transport sound, and then sets the accuracy according to the importance level. In this case, a higher importance level is set for the inspection sound, and a lower importance level is set for the transport sound.

Then, the information creation device 10 creates the accessory information according to the accuracy for each sound. For the inspection sound, information on a result of the tapping sound inspection is created as the accessory information (strictly speaking, the characteristic information). On the other hand, no information on the inspection result is created for the transport sound.

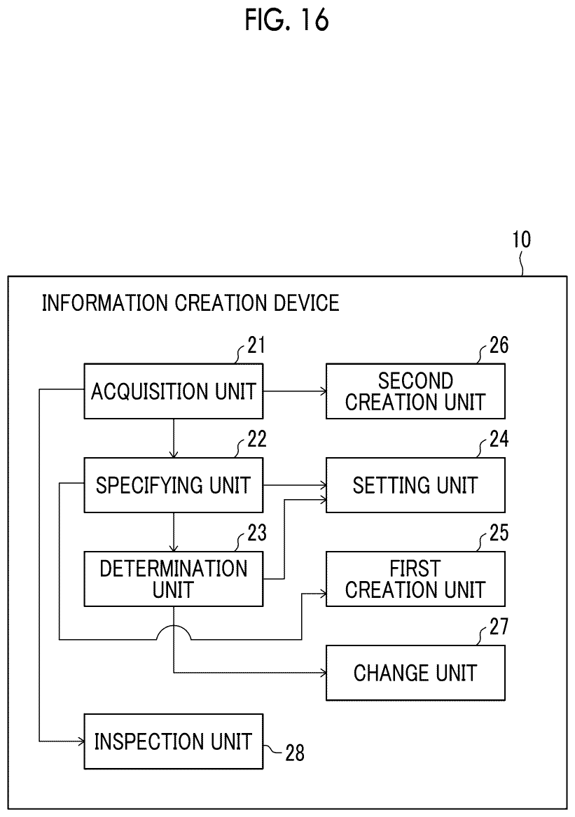

More specifically, in the second embodiment, as shown in FIG. 16, the information creation device 10 comprises the same functional units as in the first embodiment and further comprises an inspection unit 28. The inspection unit 28 inspects whether or not the sound satisfies an inspection criterion in a case in which the accuracy set for the sound included in the sound data satisfies the predetermined condition (specifically, the accuracy corresponding to the importance level). Specifically, in a case in which the accuracy for the sound is the accuracy set for the inspection sound, the inspection unit 28 inspects whether or not the sound satisfies the inspection criterion based on the characteristics of the sound (for example, the frequency and the like). The inspection criterion is a criterion for determining a quality of the inspection target article, which is the sound source of the sound (inspection sound), and is, for example, whether or not the inspection sound is an abnormal sound different from a sound of a normal product.

It should be noted that, as a unit for inspecting whether or not the sound satisfies the inspection criterion, AI for inspection, or more specifically, a learning model, may be used that determines whether or not the sound satisfies the inspection criterion based on the characteristics of the input sound.

In the second embodiment, the first creation unit 25 creates the information on the inspection result of the inspection unit 28 as the characteristic information (accessory information on the sound) for the sound of which the accuracy corresponding to the importance level satisfies the predetermined condition, that is, for the inspection sound. In this case, the first creation unit 25 may create the information on the physical characteristics (for example, the frequency, the volume, the amplitude, and the like) of the inspection sound used in a case of inspecting whether or not the inspection sound satisfies the inspection criterion, as the accessory information.

In the second embodiment, in a case in which the information on the inspection result is created, the first creation unit 25 can create the reliability information on the reliability of the inspection result as the characteristic information. The reliability is an indicator indicating the accuracy or the appropriateness of the inspection result, and is represented by, for example, a numerical value calculated from a predetermined calculation expression, a rank or a classification determined based on the numerical value, an evaluation term used in a case of evaluating the reliability, or the like.

It should be noted that, as a unit for evaluating the reliability of the inspection result, AI for reliability evaluation, more specifically, another AI for evaluating the accuracy or the likelihood of the inspection result obtained by the AI for inspection, may be used.

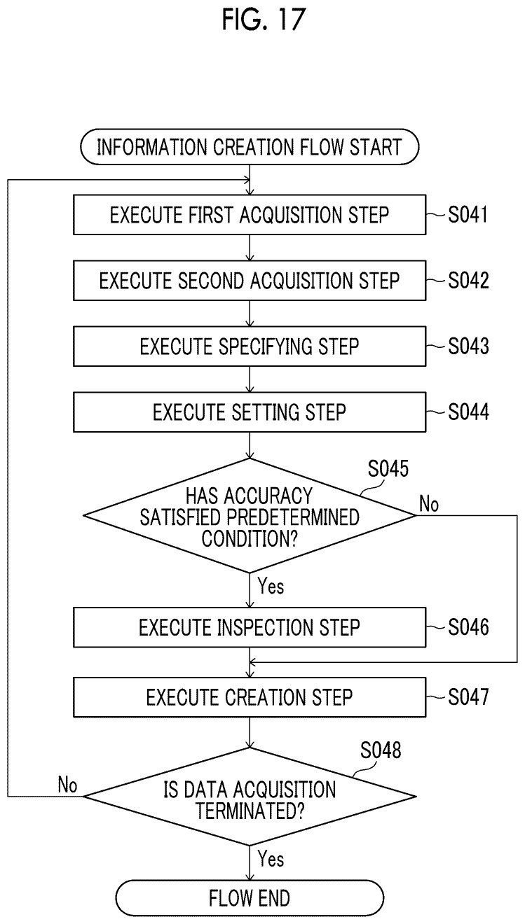

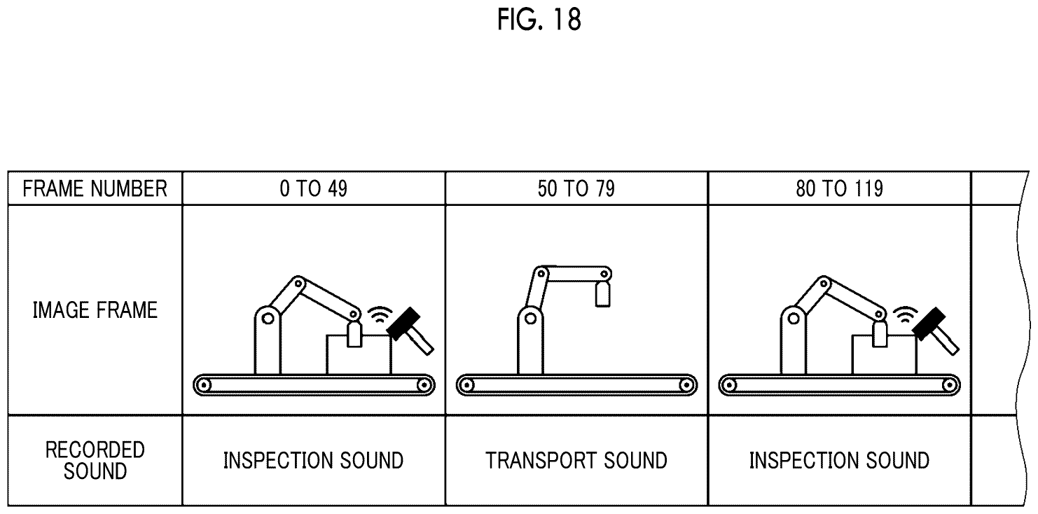

Next, an information creation flow according to the second embodiment will be described with reference to FIG. 17. The information creation flow according to the second embodiment is generally common to that of the first embodiment. Specifically, during the execution period of the tapping sound inspection, the processor 11 executes a first acquisition step (S041) of acquiring the sound data and a second acquisition step (S042) of acquiring the video data. In this case, as shown in FIG. 18, a video of inspecting the inspection target article and a video of transporting the inspection target article are alternately recorded in the video data, and the inspection sound and the transport sound are alternately recorded in the sound data.

During the execution period of the first acquisition step and the second acquisition step, the processor 11 executes a specifying step (S043) to specify the correspondence relationship between the sound and the image frame, the characteristics of the sound, the type of the sound, the sound source, and the like as the content related to the sound included in the sound data.

In the specifying step, it is specified whether or not the sound source of the sound is present within the angle of view of the corresponding image frame. For the sound source present within the angle of view, the apparatus information on the focal position (AF point) of the imaging apparatus 20 in the corresponding image frame or the gaze position of the user in the corresponding image frame is acquired, and the distance between the position indicated by the apparatus information and the position of the sound source is specified.

In addition, in a case in which the sound is the inspection sound, in the specifying step, the ID of the inspection target article that is the sound source thereof is specified, and specifically, the identification information of the inspection target article is obtained from the sensor described above to specify the ID.

After the execution of the specifying step, the processor 11 executes a setting step (S044) to set the importance level for each of the plurality of sounds (that is, the inspection sound and the transport sound) included in the sound data. In addition, in the setting step, the accuracy is set according to the set importance level for each sound or sound source. In this case, a higher importance level and accuracy are set for the inspection sound, and a lower importance level and accuracy are set for the transport sound.

Thereafter, the processor 11 determines whether or not the accuracy for each of the plurality of sounds for which the accuracy is set in the setting step satisfies the predetermined condition, specifically, whether or not the accuracy corresponds to the accuracy for the inspection sound (S045). Then, the processor 11 executes an inspection step for the sound having the accuracy satisfying the predetermined condition, that is, for the inspection sound (S046). In the inspection step, it is inspected whether or not the inspection sound satisfies the inspection criterion, or more specifically, it is inspected whether or not the inspection sound is the abnormal sound different from the sound of the normal sound.

Then, the processor 11 executes a creation step (S047) of creating the accessory information on the video data.

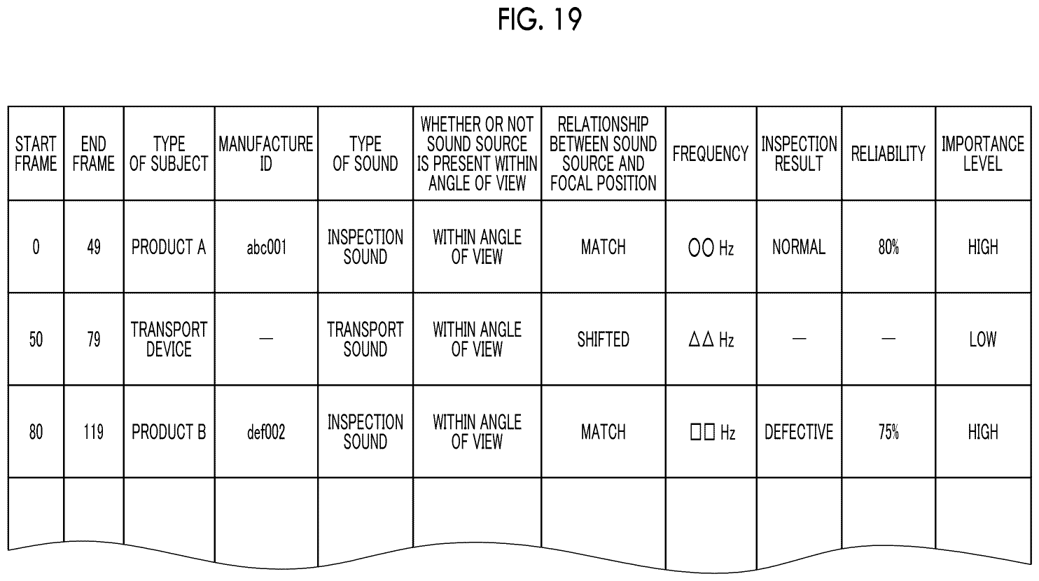

Specifically, in the creation step, the accessory information on the sound including the characteristic information is created for each of the plurality of sounds emitted from the plurality of sound sources included in the sound data. More specifically, for the inspection sound set with higher accuracy, as shown in FIG. 19, the information on the inspection result in the inspection step is created as the characteristic information in addition to the information on the frequency of the sound or the like. In addition, as shown in FIG. 19, for the inspection sound, the reliability information on the reliability of the inspection result is further created as the accessory information on the sound.

In addition, for the inspection target article, in the specifying step, the ID (identification information) thereof is specified, and the accessory information on the sound including the information on the inspection result and the reliability information is associated with the ID of the inspection target article as shown in FIG. 19.

On the other hand, as shown in FIG. 19, for the transport sound set with lower accuracy, the information on the frequency of the sound or the like is created as the characteristic information, while the information on the inspection result is not created.

The above-described series of steps are repeatedly executed during a period in which the acquisition of the video data and the sound data is continued, that is, during a period in which the tapping sound inspection is continued. Then, at the point in time when the inspection ends for all the inspection target articles and the acquisition of the data ends (S048), the information creation flow ends.

In the second embodiment, the information on the inspection result based on the sound can be created as the accessory information (characteristic information) by the above-described procedure, and the video file including the accessory information can be created. By executing the machine learning using the video file as the training data, it is possible to construct a learning model that outputs (estimates) the inspection result from the input inspection sound.

In addition, by creating the reliability information on the reliability of the inspection result as the accessory information, the learning accuracy can be improved. Specifically, the video file can be sorted (annotated) based on the reliability of the inspection result. As a result, the machine learning can be executed while ensuring the reliability of the inspection result, and a more appropriate learning result can be obtained.

### Other Embodiments

The above-described embodiments are specific examples described for easy understanding of the information creation method and the information creation device according to the embodiment of the present invention, and are merely examples, and other embodiments can also be considered.

### (File for Recording Video Data and Sound Data)

In the above-described embodiments, the video data and the sound data are acquired at the same time by capturing the video with sound via the imaging apparatus 20 provided with the microphone, and these pieces of data are included in one video file. However, the present invention is not limited to this. The video data and the sound data may be acquired by another device, and each of the data may be recorded in a separate file. In this case, it is preferable to acquire the video data and the sound data while synchronizing the video data and the sound data with each other.

### (Setting of Accuracy)

In the above-described embodiments, the importance level is set for the sound included in the sound data or the sound source of the sound, and the accuracy is set according to the importance level. It is not always necessary to set the importance level, and the accuracy may be directly set from the information on the sound or the sound source.

### (Sound Included in Sound Data)

In the above-described embodiments, the plurality of sounds included in the sound data may include a sound other than the non-verbal sound, that is, a verbal sound such as a human conversation sound. In this case, the accuracy of the accessory information (accessory information on the sound) created for the verbal sound may be set according to the importance level of the sound source of the verbal sound. For the verbal sound, for example, in a case in which the sound source thereof is present outside the angle of view, but the verbal sound is clear, the accuracy may be set in a manner different from that in a case of the non-verbal sound, such as setting the importance level and the accuracy to be relatively high.

### (Configuration of Information Creation Device)

In the above-described embodiments, a configuration has been described in which the information creation device according to the embodiment of the present invention is mounted in the imaging apparatus. That is, in the above-described embodiments, the accessory information on the video data is created by the imaging apparatus that acquires the video data and the sound data. However, the present invention is not limited to this, and the accessory information may be created by an apparatus different from the imaging apparatus, specifically, a PC, a smartphone, a tablet terminal, or the like connected to the imaging apparatus. In this case, the accessory information (specifically, the accessory information on the sound) of the video data may be created by an apparatus different from the imaging apparatus while the video data and the sound data are acquired by the imaging apparatus. Alternatively, the accessory information may be created after the video data and the sound data are acquired.

### (Configuration of Processor)

The processor provided in the information creation device according to the embodiment of the present invention includes various processors. Examples of the various processors include a CPU, which is a general-purpose processor that executes software (programs) to function as various processing units.

Moreover, the various processors include a programmable logic device (PLD), which is a processor of which a circuit configuration can be changed after manufacture, such as a field-programmable gate array (FPGA).

Further, the various processors also include a dedicated electric circuit, which is a processor having a circuit configuration specially designed for executing specific processing, such as an application-specific integrated circuit (ASIC).

In addition, one functional unit of the information creation device according to the embodiment of the present invention may be configured by one of the various processors. Alternatively, one functional unit of the information creation device according to the embodiment of the present invention may be configured by a combination of two or more processors of the same type or different types, for example, a combination of a plurality of FPGAs, a combination of an FPGA and a CPU, or the like.

Moreover, a plurality of functional units provided in the information creation device according to the embodiment of the present invention may be configured by one of the various processors, or may be configured by one processor in which two or more of the plurality of functional units are combined.

Moreover, as in the above-described embodiments, a form may be adopted in which one processor is configured by a combination of one or more CPUs and software, and the processor functions as the plurality of functional units.

In addition, for example, as typified by a system-on-chip (SoC) or the like, a form may be adopted in which a processor is used which realizes the functions of the entire system including the plurality of functional units in the information creation device according to the embodiment of the present invention with one integrated circuit (IC) chip. Further, a hardware configuration of the various processors may be an electric circuit (circuitry) in which circuit elements, such as semiconductor elements, are combined.

### EXPLANATION OF REFERENCES

10: information creation device
11: processor
12: memory
13: communication interface
14: input device
15: output device
16: storage
20: imaging apparatus
20L: imaging lens
20F: finder
21: acquisition unit
22: specifying unit
23: determination unit
24: setting unit
25: first creation unit
26: second creation unit
27: change unit
28: inspection unit
31: cover
32: housing
33: pan-tilt head

What is claimed is:

1. An information creation method comprising:
a first acquisition step of acquiring sound data including a plurality of sounds emitted from a plurality of sound sources;
a setting step of setting accuracy for the sound source or the sound; and
a creation step of creating information on characteristics of the sound as accessory information on video data corresponding to the sound data, based on the accuracy.

2. The information creation method according to claim 1,
wherein, in the setting step, an importance level is set for the sound or the sound source, and the accuracy is set according to the importance level.

3. The information creation method according to claim 1,
wherein the sound is a non-verbal sound.

4. The information creation method according to claim 1, further comprising:
a second acquisition step of acquiring video data including a plurality of image frames,
wherein, in the setting step, the accuracy for the sound source is set according to whether or not the sound source is present within an angle of view of a corresponding image frame among the plurality of image frames.

5. The information creation method according to claim 1, further comprising:
a determination step of determining whether or not the sound satisfies a predetermined criterion in a case in which the sound source is not present within an angle of view of a corresponding image frame,
wherein, in the setting step, the accuracy for the sound is set to be higher in a case in which the sound satisfies the predetermined criterion than in a case in which the sound does not satisfy the predetermined criterion.

6. The information creation method according to claim 5, further comprising:
a change step of, in a case in which the sound satisfies the predetermined criterion, changing an orientation of an imaging lens of an imaging apparatus such that the imaging lens approaches a direction of the sound source or reducing zoom magnification of the imaging apparatus such that the sound source is included in the angle of view of the image frame.

7. The information creation method according to claim 1,
wherein, in the setting step, the accuracy for the sound source is set based on a result of image recognition on the sound source in a corresponding image frame or apparatus information associated with the image frame for an imaging apparatus that captures the image frame.

8. The information creation method according to claim 7,
wherein, in the setting step, the accuracy for the sound source is set based on the apparatus information, and
the apparatus information is information on a focal position of the imaging apparatus in the image frame or a gaze position of a user of the imaging apparatus in the image frame.

9. The information creation method according to claim 1,
wherein, in the creation step, information on whether or not the sound source is present within an angle of view of a corresponding image frame is created as the accessory information.

10. The information creation method according to claim 2, further comprising:
an inspection step of inspecting whether or not the sound satisfies an inspection criterion in a case in which the accuracy according to the importance level satisfies a predetermined condition,
wherein, in the creation step, information on an inspection result obtained in the inspection step is created as the accessory information.

11. The information creation method according to claim 10,
wherein, in the creation step, reliability information on reliability of the inspection result is further created as the accessory information.

12. The information creation method according to claim 2,
wherein, in the creation step, importance level information on the importance level is created as the accessory information.

13. The information creation method according to claim 2,
wherein, in a case in which the accuracy according to the importance level satisfies a first condition, in the creation step, onomatopoeic word information in which the sound is converted into text as an onomatopoeic word is created as the accessory information.

14. The information creation method according to claim 13,
wherein, in a case in which the accuracy according to the importance level satisfies a second condition, in the creation step, mimetic word information in which a state of the sound source in a corresponding image frame is converted into text as a mimetic word is further created as the accessory information.

15. An information creation device comprising:
a processor,
wherein the processor is configured to:
acquire sound data including a plurality of sounds emitted from a plurality of sound sources;
set accuracy for the sound source or the sound; and
create information on characteristics of the sound as accessory information on video data corresponding to the sound data, based on the accuracy.

16. The information creation method according to claim 2,
wherein the sound is a non-verbal sound.

17. The information creation method according to claim 2, further comprising:
a second acquisition step of acquiring video data including a plurality of image frames,
wherein, in the setting step, the accuracy for the sound source is set according to whether or not the sound source is present within an angle of view of a corresponding image frame among the plurality of image frames.

18. The information creation method according to claim 2, further comprising:
a determination step of determining whether or not the sound satisfies a predetermined criterion in a case in which the sound source is not present within an angle of view of a corresponding image frame,
wherein, in the setting step, the accuracy for the sound is set to be higher in a case in which the sound satisfies the predetermined criterion than in a case in which the sound does not satisfy the predetermined criterion.

19. The information creation method according to claim 2,
wherein, in the setting step, the accuracy for the sound source is set based on a result of image recognition on the sound source in a corresponding image frame or apparatus information associated with the image frame for an imaging apparatus that captures the image frame.

20. The information creation method according to claim 2,
wherein, in the creation step, information on whether or not the sound source is present within an angle of view of a corresponding image frame is created as the accessory information.
